(19) United States
(12) Patent Application Publication
(10) Pub. No.: US 2017/0171265 A1
(43) Pub. Date: Jun. 15, 2017

(54) Method and electronic device based on android platform for multimedia play

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Xuehui SHI, Beijing (CN); Meng ZHANG, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/235,658

(22) Filed: Aug. 12, 2016

Related U.S. Application Data
(63) Continuation of application No. PCT/CN2016/089533, filed on Jul. 10, 2016.

(30) Foreign Application Priority Data
Dec. 14, 2015 (CN) 2015109291666

(51) Int. Cl. H04L 29/06; G06F 3/0481; H04N 21/414; H04N 21/472; H04N 21/431

(52) U.S. Cl. CPC H04L 65/4069; H04L 65/60; H04N 21/47217; H04N 21/4312; H04N 21/41407; G06F 3/0481; G06F 2203/04806; G06F 2203/04803

(57) ABSTRACT

A method and electronic device based on an Android platform for multimedia play are provided. The method includes: receiving a first play request of a user; acquiring a first multimedia resource according to the first play request; displaying, by means of a first play window, the first multimedia resource on the presentation page in a full-screen mode; acquiring a second play request of the user by means of the first play window; acquiring a second multimedia resource according to the second play request; and in response to the second play request, zooming the first play window, and displaying, by means of a second play window, the second multimedia resource in an area other than the first play window on the presentation page. A user can watch the first multimedia resource and the second multimedia resource synchronously without any block between each other, so that the user watches more content at a single time.

### CROSS-REFERENCE TO RELATED APPLICATIONS

The application is a continuation application of PCT application No. PCT/CN2016/089533 submitted on Jul. 10, 2016, which is based upon and claims priority to Chinese Patent Application No. 201510929166.6, filed with the Chinese Patent Office on Dec. 14, 2015 and entitled “METHOD, APPARATUS AND MOBILE TERMINAL DEVICE BASED ON ANDROID PLATFORM FOR MULTIMEDIA PLAY”, both of which are incorporated herein by reference in their entireties.

### TECHNICAL FIELD

This disclosure relates to the field of multimedia play, and more specifically, to a method and electronic device based on an Android platform for multimedia play.

### BACKGROUND

Currently, a video player based on an Android platform, when a user needs to watch other videos, requires to reselect the other videos after closing a current play window; if a user hopes to watch multiple videos synchronously, the user needs to open different players synchronously and watch the videos by switching the players constantly.

### SUMMARY

The present disclosure provides a method and electronic device based on an Android platform for multimedia play, so as to facilitate a user to watch.

According to a first aspect, an embodiment of the present disclosure provides a multimedia play method based on an Android platform. The method includes: receiving a first play request of a user; acquiring a first multimedia resource according to the first play request; displaying, by means of a first play window, the first multimedia resource on the presentation page in a full-screen mode; acquiring a second play request of the user by means of the first play window; acquiring a second multimedia resource according to the second play request; and in response to the second play request, zooming the first play window, and displaying, by means of a second play window, the second multimedia resource in an area other than the first play window on the presentation page.

According to a second aspect, an embodiment of the present disclosure further provides a non-transitory computer storage medium, which stores executable instructions, where the executable instructions are used to execute any of the foregoing multimedia play methods based on an Android platform of the present disclosure.

According to a third aspect, an embodiment of the present disclosure further provides an electronic device, including: at least one processor; and a memory in communication connection with the at least one processor, where the memory stores instructions that can be executed by the at least one processor, and the instructions are executed by the at least one processor, so that the at least one processor can execute any of the foregoing multimedia play methods based on an Android platform in the present disclosure.

According to the provided method and the electronic device based on an Android platform for multimedia play in the embodiments of the present disclosure, on an Android platform, a first multimedia resource is played in a full-screen mode on a first play window; when a user needs to watch a second multimedia resource, the user zooms the first play window, and plays, by means of a second play window, the second multimedia resource in other areas on the presentation page; the user can watch the first multimedia resource and the second multimedia resource synchronously without any block between each other, so that the user watches more content at a single time.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a flowchart of a multimedia play method based on an Android platform according to an embodiment of the present disclosure; and

FIG. 2 is a schematic structural diagram of a multimedia play apparatus based on an Android platform according to an embodiment of the present disclosure;

FIG. 3 is a schematic structural diagram of hardware of a device for executing a multimedia play method based on an Android platform provided by an embodiment of the present disclosure.

### DETAILED DESCRIPTION

To make the objectives, technical solutions, and advantages of the present disclosure clearer, hereinafter, the technical solutions of the present disclosure will be clearly and completely described by implementation manners with reference to the accompanying drawings in the embodiments of the present disclosure. Apparently, the described embodiments are a part rather than all of the embodiments of the present disclosure.

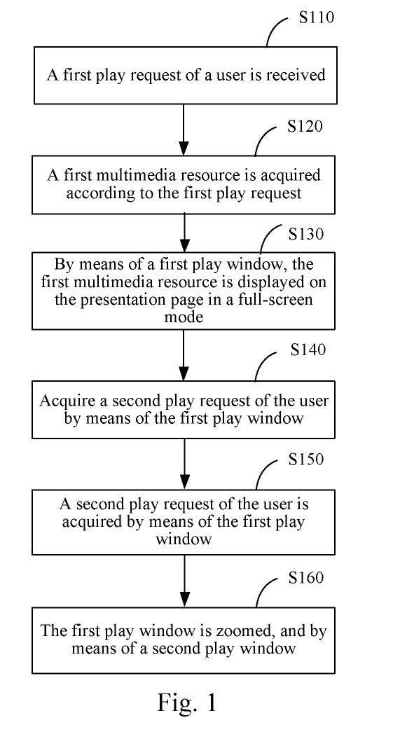

FIG. 1 is a flowchart that shows a multimedia play method based on an Android platform according to an embodiment of the present disclosure. With reference to FIG. 1, the multimedia play method based on an Android platform of this embodiment is used to play a multimedia resource on a presentation page, including the following steps:

In step S110: a first play request of a user is received.

In step S120: a first multimedia resource is acquired according to the first play request.

Instep S130: by means of a first play window, the first multimedia resource is displayed on the presentation page in a full-screen mode.

In step S140: a second play request of the user is acquired by means of the first play window.

Instep S150: a second multimedia resource is acquired according to the second play request.

A control is provided in a first play window, and a user can select to play a second multimedia resource by clicking the control. As an optional implementation manner of this embodiment, the first multimedia resource is associated with the second multimedia resource, for example, the first multimedia resource being a final of XXth World Cup and the second multimedia resource being a semi-final or group game of the XXth World Cup.

As an optional implementation manner of this embodiment, a resolution of the first multimedia resource is the same as that of the second multimedia resource. For example, the first multimedia resource and the second multimedia resource are both video resources with a resolution of 1280*720 or video resources with a resolution of 1920*1080. Or, a resolution of the first multimedia resource may also be different from that of the second multimedia resource. Whether a resolution of the first multimedia resource is the same as that of the second multimedia resource does not affect displaying the first multimedia resource in a first window and displaying the second multimedia resource in a second window.

In step S160: in response to the second play request, the first play window is zoomed, and by means of a second play window, the second multimedia resource is displayed in an area other than the first play window on the presentation page.

As an optional implementation manner of this embodiment, the first multimedia resource can be played by the first play window and the second play window synchronously, and in such an implementation manner, the first multimedia resource is the same as the second multimedia resource.

As an optional implementation manner of this embodiment, the first play window and the second play window are evenly distributed on the presentation page, for example, including but not limited to that the first play window and the second play window are distributed in an up-to-down manner on the presentation page and separately occupy half of the presentation page, or the first play window and the second play window are distributed in a left-to-right manner on the presentation page and separately occupy half of the presentation page. The multimedia resource play method based on an Android platform of this embodiment can further extend to that at least one multimedia resource is played in more than two play windows. Preferably, the more than two play windows are evenly distributed on the presentation page.

By using the multimedia play method based on an Android platform in this embodiment, on an Android platform, a first multimedia resource is played in a full-screen mode on a first play window; when a user needs to watch a second multimedia resource, the user zooms the first play window, and plays, by means of a second play window, the second multimedia resource in other areas on the presentation page; the user can watch the first multimedia resource and the second multimedia resource synchronously without any block between each other, so that the user watches more content at a single time, thereby improving watching experience of the user.

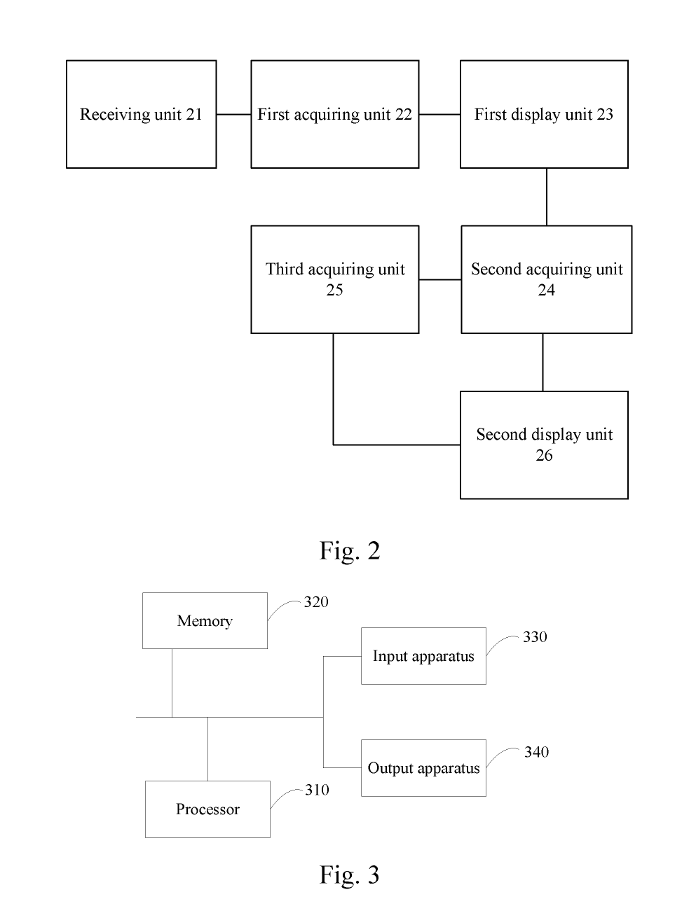

FIG. 2 is a schematic structural diagram that shows a multimedia play apparatus based on an Android platform according to an embodiment of the present disclosure.

With reference to FIG. 2, in this embodiment, the multimedia play apparatus based on an Android platform is used to play a multimedia resource on a presentation page. The apparatus includes:

a receiving unit 21 configured to receive a first play request of a user.

A first acquiring unit 22 configured to acquire a first multimedia resource according to the first play request received by the receiving unit.

A first display unit 23 configured to display in a full-screen mode, on the presentation page, the first multimedia resource acquired by the first acquiring unit.

a second acquiring unit 24 configured to acquire a second play request of the user by means of the first display unit;

a third acquiring unit 25 configured to acquire a second multimedia resource according to the second play request acquired by the second acquiring unit; and

a second display unit 26 configured to zoom the first play window in response to the second play request acquired by the second acquiring unit, and display, in an area other than the first play window on the presentation page, the second multimedia resource acquired by the third acquiring unit

As an optional implementation manner of this embodiment, a resolution of the first multimedia resource is the same as that of the second multimedia resource.

As an optional implementation manner of this embodiment, the first multimedia resource is associated with the second multimedia resource.

As an optional implementation manner of this embodiment, the first multimedia resource is the same as the second multimedia resource.

By using the multimedia play apparatus based on an Android platform in this embodiment, on an Android platform, the first display unit plays a first multimedia resource in a full-screen mode; when a user needs to watch a second multimedia resource, the user zooms the first display unit, and plays, by means of the second display unit, the second multimedia resource in other areas on the presentation page; the user can watch the first multimedia resource and the second multimedia resource synchronously without any block between each other, so that the user watches more content at a single time, thereby improving watching experience of the user.

An embodiment of the present disclosure provides a non-transitory computer storage medium, which stores executable instructions, where the \executable instructions can execute the multimedia play method based on an Android platform of any of the foregoing method embodiments of the present disclosure.

An embodiment of the present disclosure further provides an electronic device, as shown in FIG. 3, and the device includes:

one or more processors 310 and a memory 320, with one processor 310 as an example in FIG. 3.

A device for executing the multimedia play method based on an Android platform may further include: an input apparatus 330 and an output apparatus 340.

The processor 310, the memory 320, the input apparatus 330, and the output apparatus 340 can be connected by means of a bus or in other manners, with a connection by means of a bus as an example in FIG. 3.

As a non-transitory computer readable storage medium, the memory 320 can be used to store non-transitory software programs, non-transitory computer executable programs and modules, for example, a program instruction/module corresponding to the multimedia play method based on an Android platform in the embodiments of the present disclosure (for example, a receiving unit 21, a first acquiring unit 22, a first display unit 23, a second acquiring unit 24, a third acquiring unit 25, and a second display unit 26 shown in FIG. 2). The processor 310 executes various functional applications and data processing of the server, that is, implements the multimedia play method based on an Android platform of the foregoing method embodiments, by running the non-transitory software programs, instructions, and modules stored in the memory 320.

The memory 620 may include a program storage area and a data storage area, where the program storage area may store an operating system and at least one application needed by function; the data storage area may store data created by use of the multimedia play method based on an Android platform, and the like. In addition, the memory 620 may include a high-speed random access memory, and also may include a non-transitory memory, such as at least one disk storage device, flash storage device, or other non-transitory solid-state storage devices. In some embodiments, the memory 620 optionally includes memories remotely disposed with respect to the processor 610, and the remote memories may be connected, via a network, to the multimedia play apparatus based on an Android platform. Examples of the foregoing network include but are not limited to: the Internet, an intranet, a local area network, a mobile communications network, and a combination thereof.

The input apparatus 630 can receive entered digit or character information, and generate key signal inputs relevant to user setting and functional control of the multimedia play apparatus based on an Android platform. The output apparatus 640 may include a display device, for example, a display screen, etc.

The one or more modules are stored in the memory 620, and execute the multimedia play method based on an Android platform in any one of the foregoing method embodiments when being executed by the one or more processors 610.

The foregoing product can execute the method provided in the embodiments of the present disclosure, and has corresponding functional modules for executing the method and beneficial effects. The method provided in the embodiments of the present disclosure can be referred to for technical details that are not described in detail in the embodiment.

The electronic device in the embodiment of the present disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the present disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the present disclosure.

1. A multimedia play method based on an Android platform, applied in an electronic device, wherein the method comprises:
receiving a first play request of a user;
acquiring a first multimedia resource according to the first play request;
displaying, by means of a first play window, the first multimedia resource on a presentation page in a full-screen mode;
acquiring a second play request of the user by means of the first play window;
acquiring a second multimedia resource according to the second play request; and
in response to the second play request, zooming the first play window, and displaying, by means of a second play window, the second multimedia resource in an area other than the first play window on the presentation page.

2. The method according to claim 1, wherein the first play window and the second play window are evenly distributed on the presentation page.

3. The method according to claim 1, wherein a resolution of the first multimedia resource is the same as that of the second multimedia resource.

4. The method according to claim 1, wherein the first multimedia resource is associated with the second multimedia resource.

5. The method according to claim 1, wherein the first multimedia resource is the same as the second multimedia resource.

6. A non-transitory computer storage medium storing executable instructions that, when executed by an electronic device, cause the electronic device to:
receive a first play request of a user;
acquire a first multimedia resource according to the first play request;
display in a full-screen mode, on a presentation page, the first multimedia resource;
acquire a second play request of the user by means of a first play window;
acquire a second multimedia resource according to the second play request; and
zoom the first play window in response to the second play request, and display, in an area other than the first play window on the presentation page, the second multimedia resource.

7. The non-transitory computer storage medium according to claim 6 wherein a resolution of the first multimedia resource is the same as that of the second multimedia resource.

8. The non-transitory computer storage medium according to claim 6, wherein the first multimedia resource is associated with the second multimedia resource.

9. The non-transitory computer storage medium according to claim 6, wherein the first multimedia resource is the same as the second multimedia resource.

10. (canceled)

11. The non-transitory computer storage medium according to claim 6, wherein the first play window and the second play window are evenly distributed on the presentation page.

12. An electronic device comprising:
at least one processor; and
a memory in communication connection with the at least one processor and for storing instructions executable by the at least one processor, wherein execution of the instructions by the at least one processor cause the at least one processor to:
receive a first play request of a user;
acquire a first multimedia resource according to the first play;
display in a full-screen mode, on a presentation page, the first multimedia resource;
acquire a second play request of the user;
acquire a second multimedia resource according to the second play request and
in response to the second play request, zooming the first play window, and displaying, in an area other than the first play window on the presentation page, the second multimedia resource.

13. The electronic device according to claim 12, wherein the first play window and the second play window are evenly distributed on the presentation page.

14. The electronic device according to claim 12, wherein a resolution of the first multimedia resource is the same as that of the second multimedia resource.

15. The electronic device according to claim 12, wherein the first multimedia resource is associated with the second multimedia resource.

16. The electronic device according to claim 12, wherein the first multimedia resource is the same as the second multimedia resource.
